(19) United States
(12) Patent Application Publication
(10) Pub. No.: US 2009/0293830 A1
(43) Pub. Date: Dec. 3, 2009

(54) AIR INTAKE BOX

(76) Inventor: MU-CHEN HUNG, Youn-An Industrial Park (TW)

Correspondence Address: LEONG C LEI, PMB # 1008, 1867 YGNACIO VALLEY ROAD, WALNUT CREEK, CA, 94598, US

(21) Appl. No.: 12/127,826

(22) Filed: May 28, 2008

(51) Int. Cl. F02M 35/10

(52) U.S. Cl. 123/184.47

(57) ABSTRACT

An air intake box is integrally molded and includes an inlet section that has a tail end extending and forming a bent and upward inclined guide section and a connection section connected to the guide section. External air enters the inlet section through an air-inlet port and is then guided upward by the guide section and further guided toward an engine through a sleeve fit into the connection section to make the air intake more smooth and increase the amount of air intake for realizing cooling of a belt of a transmission system and preventing water from directly entering the engine transmission system so as to protect the belt of the transmission system from failure due to slippage and ensure that the engine power can be effectively transmitted through the transmission system.

### BACKGROUND OF THE INVENTION

(a) Technical Field of the Invention

The present invention relates to an improved air intake box, and in particular to an air intake box that is integrally molded and is effective in increasing the amount of air intake and preventing humidity or dust from directly entering a engine transmission system so as to have that advantage that the integral molding makes it less susceptible to malfunction, reduces developing cost of mold, and has less risk of water leakage due to poor sealing, also having the advantages of reduced complication of assembling, simplification of the assembling process in an assembling line, reduced working hour for replacement and maintenance.

(b) Description of the Prior Art

An all-terrain vehicle (ATV) or a utility vehicle (UTV) and other special purpose vehicles are often subjected to special and poor terrains and environments. To effectively isolate humidity or water from entraining the cooling air that enters an engine transmission system of the vehicle, while still maintaining desired cooling of a belt of the transmission system is a vital important factor to prevent the belt from slippage due to contacting water and losing performance of power transmission. A conventional air intake box, which is designated at 1 as shown in FIG. 1, comprises an upper cover 11 and a lower bottom 12 bonded together. The lower bottom 12 forms on a right side face thereof an air inlet opening 13. Formed inside the air intake box 1 are two spaced, first and second baffles 14, 15. The lower bottom 12 forms a water drain hole 16 at a location between the first baffle 14 and the air inlet opening 13. A fitting hole 17 is formed in the lower bottom 12 on the left hand side of the second baffle 15. The fitting hole 17 receives and positions a sleeve 18 with a spacing that defines an air passage 19 left between the sleeve 18 and the upper cover 11. External air is guided into the air intake box 1 through the air inlet opening 13 and gets into collision with the first baffle 14, which redirects the air upward for subsequent movement. The air then collides with the second baffle 15 and is thus redirected downward. After getting into collision with the sleeve 18, the air is guided into the sleeve 18 through the upper air passage 19 for further moving toward the engine. Such a construction of the air intake box 1 is effective to guide in external air for realizing cooling of the belt of the transmission system. However, the external air that enters the air intake box 1 is successively put into collision with the first baffle 14, the second baffle 15, and the sleeve 18 that extends into the air intake box 1. Although such collisions facilitate guiding the moving direction of the air, yet such collisions imposes resistance against the movement or flow of the air, leading to unsmooth air intake and reduction of air intake, as well as occurrence of turbulences. All these lessen the supply of cooling air, making it ineffective to remove the heat generated by high speed abrasion of the belt during a long term or high speed operation of a vehicle, and eventually leading to burning out of the belt and failure to further operation of the vehicle. The service life of the vehicle may get shortened due to frequent change of parts. It is thus desired to overcome such a problem.

### SUMMARY OF THE INVENTION

In view of the drawbacks of unsmooth air intake and reduction of drawn air and occurrence of turbulences that are caused by the resistance against air flow due to unsmooth air intake, the present invention is aimed to provide a n air intake box that is integrally molded, comprising an inlet section that has a tail end extending and forming a bent and upward inclined guide section and a connection section connected to the guide section. External air enters the inlet section through an air-inlet port and is then guided upward by the guide section and further guided toward an engine through a sleeve fit into the connection section to make the air intake more smooth and increase the amount of air intake for realizing cooling of a belt of a transmission system and preventing water from directly entering the engine transmission system so as to protect the belt of the transmission system from failure due to slippage and ensure that the engine power can be effectively transmitted through the transmission system.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a cross-sectional view of a conventional air intake box;

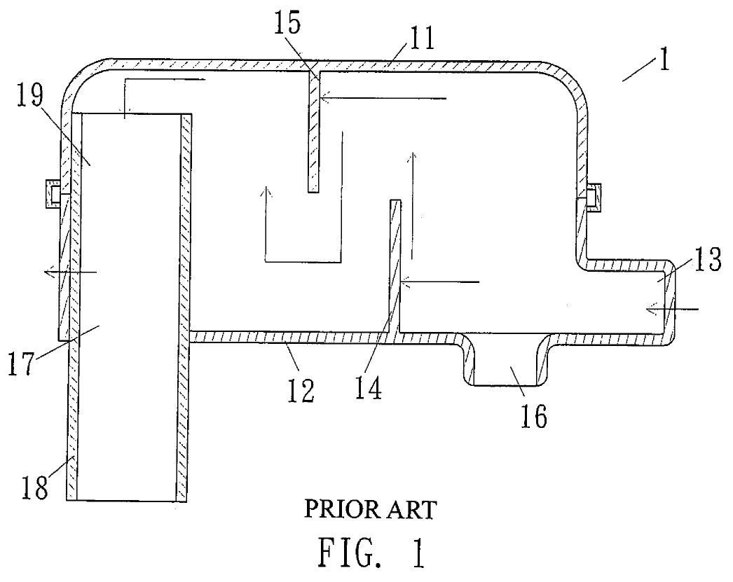

FIG. 2 is an exploded view of an air intake box constructed in accordance with a preferred embodiment of the present invention;

FIG. 3 is a cross-sectional view of FIG. 2; and

FIG. 4 is a cross-sectional view illustrating the operation of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

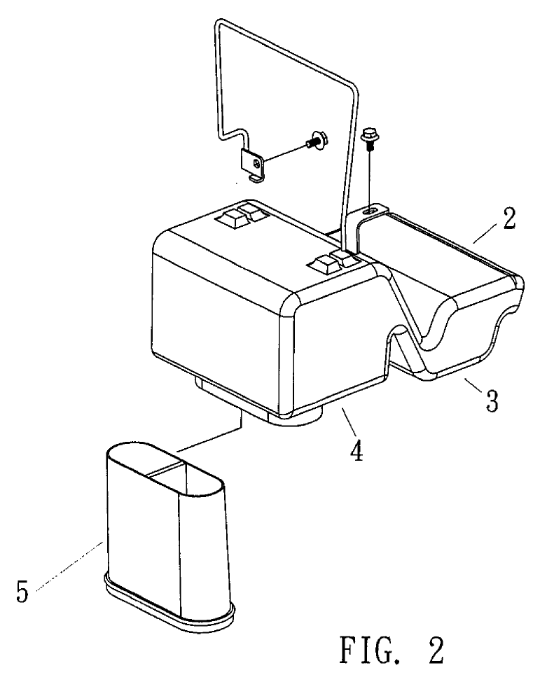

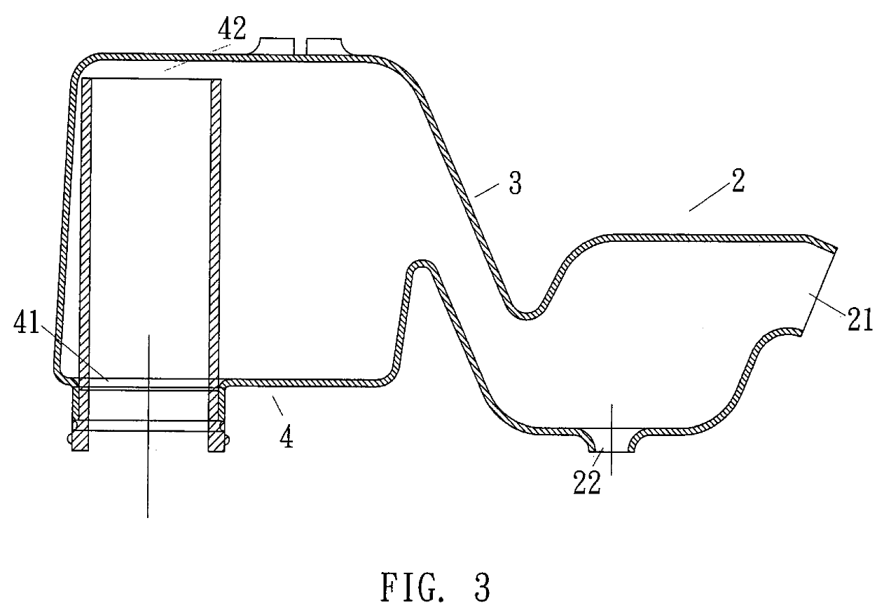

With reference to the drawings and in particular to FIGS. 2 and 3, an air intake box constructed in accordance with the present invention is shown. The air intake box of the present invention is integrally formed as a single piece part, which is constituted by an inlet section 2, a guide section 3, and a connection section 4. The inlet section 2 has a front, leading side forming an open air-inlet port 21. The inlet section 2 has a bottom in which two water drain holes 22 are defined. The guide section 3 is connected to a tail end of the inlet section 2 and is set in a bent and upward inclined configuration. A tail end of the guide section 3 is extended to joint to the connection section 4 that is located at an altitude higher than the inlet section 2. A fitting hole 41 is formed in a bottom of the connection section 4 at a tail end thereof. The fitting hole 41 functions to receive the fitting of a sleeve 5. The sleeve 5, after fit into the fitting hole 41, forms a space with an upper side of the connection section 4 to define an air passage 42 so as to allow external air to get into the sleeve 5 through the air passage 42, leading to more smooth intake of air and increase of the amount of air intake.

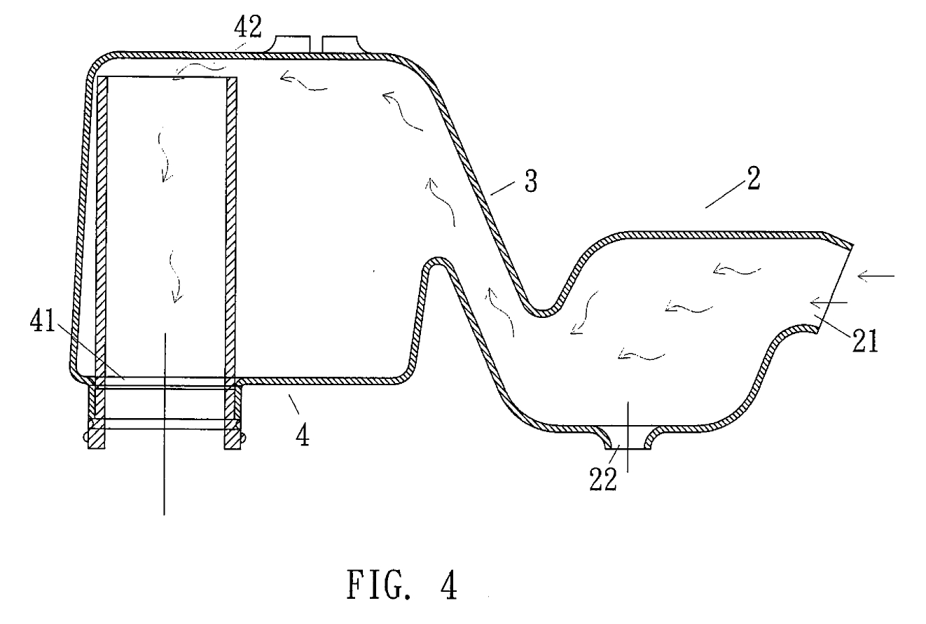

Also referring to FIG. 4, external air passes through the air-inlet port 21 of the inlet section 2 to get inside the inlet section 2. Due to the bent and upward inclined configuration of the guide section 3, the external air entering the air intake box is guided to move further and upward by following the guide section 3 to reach the upper portion of the connection section 4. Thereafter, the air moves along the air passage 42 to enter the sleeve 5 that is fit into the interior of the connection section 4. Thus, the external air can efficiently flow toward the engine. Due to the guidance in the upward direction realized by the guide section 3, the external air entering the air intake box can form a smooth flow that is substantially subjected to no collision with parts of the air intake box. Thus the amount of the external air entering the air intake box is increased and so is the air that is guided in, leading to realization of effective cooling of the heat generated due to high speed abrasion of the belt of the transmission system. Further, since the connection section 4 is set in a condition of being located at an altitude higher than the inlet section 2, event a vehicle that employs the air intake box of the present invention travels through a poor terrain, where water is ceased to get into the interior of the connection section 4, due to fact that the connection section 4 is substantially higher than the inlet section 2, there is no risk that the water flows through the air passage 42 into the sleeve 5 and then moves toward the engine. By simply removing the sleeve 5, water can be drained through the fitting hole 41, making the handling of the undesired water entering the air intake box easy and efficient.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An air intake box, which is integrally formed, comprising an inlet section, a guide section, and a connection section, wherein the inlet section has a leading side forming an open air-inlet port; the guide section is connected to a tail end of the air inlet section and has a bent and upward inclined configuration, a tail end of the guide section being extended to joint to that connection section that is located higher than the inlet section; and the connection section has a bottom forming a fitting hole at a tail end thereof, the fitting hole receiving and retaining a sleeve fit therein.
